(19) United States
(12) Patent Application Publication
(10) Pub. No.: US 2005/0188177 A1
(43) Pub. Date: Aug. 25, 2005

(54) Method and apparatus for real-time multithreading

(75) Inventors: Guang R. Gao, Newark, DE (US); Kevin B. Theobald, Hillsboro, OR (US)

Correspondence Address: CONNOLLY BOVE LODGE & HUTZ, LLP, P O BOX 2207, WILMINGTON, DE, 19899, US

(73) Assignee: The University of Delaware

(21) Appl. No.: 10/515,207

(22) PCT Filed: May 30, 2003
(86) PCT No.: PCT/US03/17223

(30) Foreign Application Priority Data
May 31, 2002 (US) 60384495

(51) Int. Cl. G06F 15/00

(52) U.S. Cl. 712/1

(57) ABSTRACT

A computer architecture, hardware modules, and a software method, collectively referred to as “EVISA,” are described that allow low-overhead multithreading program execution to be performed in such a way as to keep all processors usefully busy and satisfy real-time timing constraints. The architecture can be incorporated into the design of a multithreading instruction processor, or can be used as a separate architectural module in conjunction with pre-existing non-multithreading processors as well as specialized Intellectual Property (IP) core modules for embedded applications.

### CLAIM FOR PRIORITY

The present application claims priority of U.S. Provisional Patent Application Ser. No. 60/384,495, filed May 31, 2002, the disclosure of which being incorporated by reference herein in its entirety.

The present application has Government rights assigned to the National Science Foundation (NSF), the National Security Agency (NSA), and the Defense Advanced Research Projects Agency (DARPA).

### BACKGROUND OF THE INVENTION

A. Field of the Invention

The present invention relates generally to computer architectures, and, more particularly to a method and apparatus for real-time multithreading.

B. Description of the Related Art

Multitasking operating systems have been available throughout most of the electronic computing era. In multitasking operating systems, a computer processor executes more than one computer program concurrently by switching from one program to another repeatedly. If one program is delayed, typically when waiting to retrieve data from disk, the central processing unit (CPU) switches to another program so that useful work can be done in the interim. Switching is typically very costly in terms of time, but is still faster than waiting for the data.

Recently, computer designers have started to apply this idea to substantially smaller units of work. Conventional single-threaded processors are inefficient because the processor must wait during the execution of some steps. For example, some steps cause the processor to wait for a data resource to become available or for a synchronization condition to be met. However, the time wasted during this wait is usually far less than the time for a multitasking operating system to switch to another program (assuming another is available). To keep the processor busy and increase efficiency, multithreaded processors were invented.

In a multithreaded processor, the work to be performed by the computer is represented as a plurality of threads, each of which performs a specific task. Some threads may be executed independently of other threads, while some threads may cooperate with other threads on a common task. Although the processor can execute only one thread, or a limited number of threads, at one time, if the thread being executed must wait for the occurrence of an external event such as the availability of a data resource or synchronization with another thread, then the processor switches threads. This switching is much faster than the switching between programs by a multitasking operating system, and may be instantaneous or require only a few processor cycles. If the waiting time exceeds this switching time, then processor efficiency is increased.

Computer system architectures and programming trends are moving toward multi-threaded operations rather than single, sequential tasks. To multithread a program, it is decomposed by the compiler into more than one thread. Some conventional computer technology also makes use of multithreading capabilities that are integral to the design of some instruction processors. However, current multithreading technologies primarily focus on interleaving multiple independent threads of control in order to improve overall utilization of the arithmetic units in the CPU. In this respect they are similar to multitasking operating systems, albeit far more efficient. Unfortunately, additional mechanisms (hardware or software) are needed to coordinate threads when several of them cooperate on a single task. These mechanisms tend to consume much time, relative to the speed of the CPU. To maintain CPU efficiency, programmers must make use of these mechanisms as sparingly as possible. Programmers therefore are required to minimize the number of threads and the interactions among these threads, which may limit the performance achievable on many applications which intrinsically require a larger number of threads and/or greater interactions among cooperating threads.

Thus, there is a need in the art for a multithreading apparatus and method that overcomes the deficiencies of the related art.

### SUMMARY OF THE INVENTION

The present invention solves the problems of the related art by providing a method and apparatus for real-time multithreading that are unique in at least three areas. First, an architectural module of the present invention provides multithreading in which control of the multithreading can be separated from the instruction processor. Second, the design of a multithreading module of the present invention allows real-time constraints to be handled. Finally, the multithreading module of the present invention is designed to work synergistically with new programming language and compiler technology that enhances the overall efficiency of the system.

The present invention provides several advantages over conventional multithreading technologies. Conventional multithreading technologies require additional mechanisms (hardware or software) to coordinate threads when several of them cooperate on a single task. In contrast, the method and apparatus of the present invention includes efficient, low-overhead event-driven mechanisms for synchronizing between related threads, and is synergistic with programming language and compiler technology. The method and apparatus of the present invention further provides smooth integration of architecture features for handling real-time constraints in the overall thread synchronization and scheduling mechanism. Finally, the apparatus and method of the present invention separates the control of the multithreading from the instruction processor, permitting fast and easy integration of existing specialized IP core modules, such as signal processing and encryption units, into a System-On-Chip design without modifying the modules' designs.

The method and apparatus of the present invention can be used advantageously in any device containing a computer processor where the processor needs to interact with another device (such as another processor, memory, specialized input/output or functional unit, etc.), and where the interaction might otherwise block the progress of the processor. Some examples of such devices are personal computers, workstations, file and network servers, embedded computer systems, hand-held computers, wireless communications equipment, personal digital assistants (PDAs), network switches and routers, etc.

By keeping the multithreading unit separate from the instruction processor in the present invention, a small amount of extra time is spent in their interaction, compared to a design in which multithreading capability is integral to the processor. This trade-off is acceptable as it leads to greater interoperability of parts, and has the advantage of leveraging off-the-shelf processor design and technology.

Because the model of multithreading in the present invention differs from other models of parallel synchronization, it involves distinct programming techniques. Compilation technology developed by the inventors of the present invention make the programmer's task considerably easier.

In accordance with the purpose of the invention, as embodied and broadly described herein, the invention comprises a computer-implemented apparatus comprising: one or more multithreading nodes connected by an interconnection network, each multithreading node comprising: an execution unit (EU) for executing active short threads (referred hereinafter as fibers), the execution unit having at least one computer processor and access to connections with memory and/or other external components; a synchronization unit (SU) for scheduling and synchronizing fibers and procedures, and handling remote accesses; two queues, the ready queue (RQ) and the event queue (EQ), through which the EU and SU communicate, the ready queue providing information received from the synchronization unit to the at least one computer processor of the execution unit, and the event queue providing information received from the at least one computer processor of the execution unit to the synchronization unit; a local memory interconnected with and shared by the execution unit and the synchronization unit; and a link to the interconnection network and interconnected with the synchronization unit.

Further in accordance with the purpose of the invention, as embodied and broadly described herein, the invention comprises a computer-implemented method, comprising the steps of: providing one or more multithreading nodes connected by an interconnection network; and providing for each multithreading node: an execution unit (EU) for executing active fibers, the execution unit having at least one computer processor and access to connections with memory and/or other external components; a synchronization unit (SU) for scheduling and synchronizing fibers and procedures, and handling remote accesses; two queues, the ready queue (RQ) and the event queue (EQ), through which the EU and SU communicate, the ready queue providing information received from the synchronization unit to the at least one computer processor of the execution unit, and the event queue providing information received from the at least one computer processor of the execution unit to the synchronization unit; a local memory interconnected with and shared by the execution unit and the synchronization unit; and a link to the interconnection network and interconnected with the synchronization unit.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic diagram showing the EVISA multithreading architectural module in accordance with an aspect of the present invention;

FIG. 2 is a schematic diagram showing the relevant datapaths of a synchronization unit (SU) used in the module shown in FIG. 1; and

FIG. 3 is a schematic diagram illustrating the situation arising from having two instances of the same fiber in the same procedure instance simultaneously active, using the module shown in FIG. 1.

### DETAILED DESCRIPTION OF EMBODIMENTS OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

The present invention is broadly drawn to a method and apparatus for real-time multithreading. More specifically, the present invention is drawn to a computer architecture, hardware modules, and a software method, collectively referred to as “EVISA,” that allow low-overhead multithreading program execution to be performed in such a way as to keep all processors usefully busy and satisfy real-time timing constraints. The architecture can be incorporated into the design of a multithreading instruction processor, or can be used as a separate architectural module in conjunction with pre-existing non-multithreading processors as well as specialized Intellectual Property core modules for embedded applications.

A. Summary Of The EVISA Thread Model

Under the EVISA model, the instructions of a program are divided into three layers: (1) threaded procedures; (2) fibers; and (3) individual instructions. The first two layers form EVISA's two-layer thread hierarchy. Each layer defines ordering constraints between components of that layer and a mechanism for determining a schedule that satisfies those constraints.

Individual instructions are at the lowest level. Individual instructions obey sequential execution semantics, where the next instruction to execute immediately follows the current instruction unless the order is explicitly changed by a branch instruction. Methods to exploit modest amounts of parallelism by allowing independent nearby instructions to execute simultaneously, known as instruction-level parallelism, are well-known and are permitted so long as the resulting behavior is functionally equivalent to sequential execution.

As used herein, the term “fiber” means a collection of instructions sharing a common context, consisting of a set of registers and the identifier of a frame containing variables shared with other fibers. When a processor begins executing a fiber, it executes the designated first instruction of the fiber. Subsequent instructions within the fiber are determined by the instructions' sequential semantics. Branch instructions (whether conditional or unconditional) are allowed, typically to other instructions within the same fiber. Calls to sequential procedures are also permitted within a fiber. A fiber finishes execution when an explicit fiber-termination marker is encountered. The fiber's context remains active from the start of the fiber to its termination.

Since a fiber is a collection of instructions sharing a common context, it is possible for two or more fibers to share the same collection of instructions, provided each has a unique context. This is similar to “re-entrant procedures” in conventional computers, in which multiple copies of the same section of a program use different portions of the program stack. The term “fiber code” as used herein refers to the instructions of a fiber, without context, i.e., the portion of the program executed by a fiber.

Fibers are normally non-preemptive. Once a fiber begins execution, it is not suspended, nor is its context removed from active processing except under special circumstances. These include the generation of a trap by a run-time error, and the interruption of a fiber in order to satisfy a real-time constraint. Thus, fibers are scheduled atomically. A fiber is “enabled” (made eligible to begin execution as soon as processing resources are available) when all data and control dependences have been satisfied.

Sync slots and sync signals are used to make this determination. Sync signals (possibly with data attached) are produced by a fiber or component which satisfies a data or control dependence, and tell the recipient that the dependence has been met. A sync slot records how many dependences remain unsatisfied. When this count reaches zero, a fiber associated with this sync slot is enabled, for it now has all data and control permissions necessary for execution. The count is reset to allow a fiber to run multiple times.

As used herein, the term “threaded procedure” means a collection of fibers sharing a common context which persists beyond the lifetime of a single fiber. This context consists of a procedure's input parameters, local variables, and sync slots. The context is stored in a frame, dynamically allocated from memory when the procedure is invoked. As with fibers, the term “procedure code” refers to the fiber codes comprising the instructions belonging to a threaded procedure.

Threaded procedures are explicitly invoked by fibers within other procedures. Among the fiber codes in a threaded procedure code, one is designated the initial fiber. When a threaded procedure is invoked and its frame is ready, the initial fiber is enabled, and begins execution as soon as processing resources are available. Other fibers in the same threaded procedure may only be enabled using sync slots and sync signals. An explicit terminate command is used to terminate both the fiber which executes this command and the threaded procedure to which the fiber belongs, which causes the frame to be deallocated. Since procedure termination is explicit, no garbage collection is needed for these frames.

B. Description Of The EVISA Multithreading Architectural Module

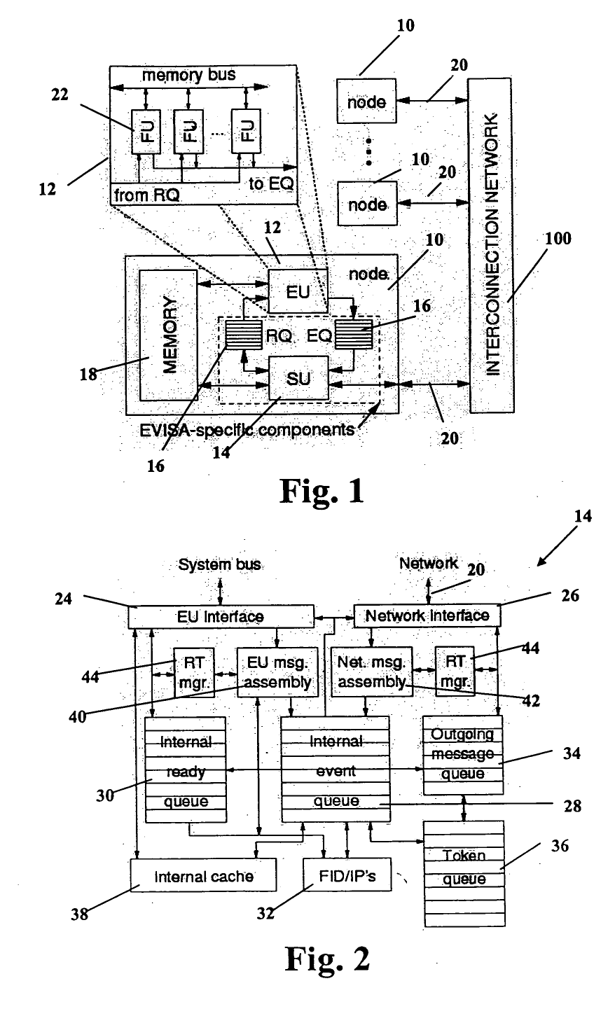

This section explains how to use a regular processor, for that which it can do well (running sequential fibers), and move the tasks specific to the EVISA thread model to a custom co-processor module. However, the multithreading capabilities may alternatively be designed directly into the processor instead of making it a separate module. A machine in the former configuration (with separate co-processor) might look something like the one shown in FIG. 1. The computer consists of one or more multithreading nodes 10 connected by a network 100. Each node 10 includes the following five components: (1) an execution unit (EU) 12 for executing active fibers; (2) a synchronization unit (SU) 14 for scheduling and synchronizing fibers and procedures, and handling remote accesses; (3) two queues 16, the ready queue (RQ) and the event queue (EQ), through which the EU 12 and SU 14 communicate; (4) local memory 18, shared by the EU 12 and SU 14; and (5) a link 20 to the interconnection network 100. Synchronization unit 14 and queues 16 are specific to the EVISA architecture, as shown in FIG. 1.

The simplest implementation would use one single-threaded COTS processor for each EU 12. The term “COTS” (commercial off-the-shelf) describes ready-made products that can easily be obtained (the term is sometimes used in military procurement specifications). However, the EU 12 in this model can have processing resources for executing more than one fiber simultaneously. This is shown in FIG. 1 as a set of parallel Fiber Units (FUs) 22, where each FU 22 can execute the instructions contained within one fiber These FUs could be separate processors (as in a conventional SMP machine); alternately they could collectively represent one or more multithreaded processors capable of executing multiple threads simultaneously.

The SU 14 performs all multithreading features specific to the EVISA two-level threading model and generally not supported by COTS processors. This includes EU 12 and network interfacing, event decoding, sync slot management, data transfers, fiber scheduling, and load balancing.

The EU 12 and SU 14 communicate with each other through the ready queue (RQ) 16 and the event queue (EQ) 16. If a fiber running on the EU 12 needs to perform an operation relating to other fibers (e.g., to spawn a new fiber or send data to another fiber), it will send a request (an event) to the EQ 16 for processing by the SU 14. The SU 14, meanwhile, manages the fibers, and places any fiber ready to execute in the RQ 16. When an FU 22 within the EU 12 finishes executing a fiber; it goes to the RQ 16 to get a new fiber to execute. The queues 16 may be implemented using off-the-shelf devices such as FIFO (first in first out) chips, incorporated into a hardware SU, or kept in main memory.

FIG. 2 shows the relevant datapaths of an SU module 14, either a separate chip, a separate core placed on a die with a CPU core, or logic fully integrated with the CPU. Preferably, the event and ready queues are incorporated into the SU itself, as shown in FIG. 2. FIG. 2 shows two interfaces to the SU 14, an interface 24 to the system bus and an interface 26 to the network. In this embodiment, the EU 12 accesses both the EQ 16 and the RQ 16 through the system bus interface 24, and the SU 14 accesses the system memory 18 through the same system bus interface 24. The link 20 to the network is accessed through a separate interface 26. Alternative implementations may use other combinations of interfaces. For instance, the SU 14 could use separate interfaces for reading the RQ 16, writing the EQ 16, and accessing memory 18, or use the system bus interface 24 for accessing the network link 20.

The SU 14 has the following storage areas. At the core of the SU 14 is an Internal Event Queue 28, which is a pool of uncompleted events waiting to be finished or forwarded to another node. There may be times when many events are generated at the same time, which will fill the queue 28 faster than the SU 14 can process them. For practical reasons, the SU 14 can work on only a small number of events simultaneously. The other events wait in a substantial overflow section, which may be stored in an external memory module accessed only by the SU itself, to be processed in order.

An Internal Ready Queue 30 holds a list of fibers that are ready to be executed, i.e., all dependencies have been satisfied. Each entry in the Internal RQ 30 has bits dedicated to each of the following fields: (I) an Instruction Pointer (IP), which is the address of the designated first instruction of the fiber code for that fiber, (2) a Frame Identifier (FID), which is the address of the frame containing the context of the threaded procedure to which the fiber belongs; (3) a properties field, identifying certain real-time priorities and constraints; (4) a timestamp, used for enforcing real-time constraints; and (5) a data value which may be accessed by the fiber once it has started execution. Fields (3), (4) and (5) are designed to support special features of the EVISA model in an embodiment of the present invention, but may be omitted in producing a reduced version of EVISA.

A FID/IP section 32 stores information relevant to each fiber currently being executed by the EU 12, including the FID and the threaded procedure corresponding to that fiber. The SU 14 needs to know the identity of every fiber currently being executed by the EU 12 in order to enforce scheduling constraints. The SU 14 also needs this information so that local objects specified by EVISA operations sent from the EU 12 to the SU 14 are properly identified. If there are multiple Fiber Units FU 22 in the EU 12, the SU 14 needs to be able to identify the source (FU) of each event in the EQ 16. This can be done, for instance, by tagging each message written to the SU 14 by the EU 12 with an FU identifier, or by having each FU 22 write to a different portion of the SU address space.

The remaining storage areas of the SU 14 are as follows. An Outgoing Message Queue 34 buffers messages that are waiting to go out over the network. A Token Queue 36 holds all pending threaded procedure invocations on this node that have not yet been assigned to a node. An Internal Cache 38 holds recently-accessed sync slots and data read by the SU 14 (e.g., during data transfers). Sync slots are stored as part of a threaded procedure's frame, but most slots should be cached within the SU for efficiency.

The storage areas of the SU 14 are controlled by the following logic blocks. The EU Interface 24 handles loads and stores coming from the system bus. The EU 12 issues a load whenever it needs a new fiber from the RQ 16. When this occurs, the EU interface 24 reads an entry from the Internal RQ 30 and puts it on the system bus. The EU interface 24 also updates the corresponding entry in the FID/IP table 32. The EU 12 issues a store whenever it issues an event to the SU 14. Such stores are forwarded to an EU message assembly area 40. Finally, the EU interface 24 drives the system bus when the SU 14 needs to access main memory 18 (e.g., to transfer data).

The EU message assembly area 40 collects sequences of stores from the EU interface 24 and may convert slot and fiber numbers to actual addresses. Completed events are put into the EQ 16. The Network Interface 26 drives the interface to the network. Outgoing messages are taken from the outgoing message queue 34. Incoming messages are forwarded to a Network message assembly area 42. The Network message assembly area 42 is like the EU message assembly area 40, and injects completed events into the EQ 16. The Internal Event Queue 28 has logic for processing all the events in the EQ 16, and accesses all the other storage areas of the SU 14.

A distributed real-time (RT) manager 44 helps ensure that real-time constraints are satisfied under the EVISA model. The RT manager 44 has access to the states of all queues and all interfaces, as well as a real-time clock. The RT manager 44 ensures that events, messages and fibers with high priority and/or real-time constraints are placed ahead of objects with lesser priority.

In applying the EVISA architecture to communications applications, the SU 14 can also be extended to support invocation of threaded procedures upon receipt of messages from the interconnection network which may be connected to local area networks, wide area networks or metropolitan area networks via appropriate interfaces. In this extension an SU 14 is provided with associations between message types and threaded procedures for processing them.

The SU 14 has a very decentralized control structure. The design of FIG. 1 shows the SU 14 interacting with the EU 12, the network 100, and the queues 16. These interactions can all be performed concurrently by separate modules with proper synchronization. For instance, the Network Interface 26 could be reading a request for a token from another node, while the EU interface 24 is serving the head of the Ready Queue 16 to the EU 12 and the Internal Event Queue 28 is processing one or more EVISA operations in progress. Simple hardware interlocks are used to control simultaneous access to resources shared by multiple modules, such as buffers.

There are several advantages to using a separate hardware SU instead of emulating the SU functions in software. First, auxiliary tasks can be efficiently offloaded onto the SU 14. If a single processor were used in each node, that processor would have to handle fiber support, diverting CPU resources from the execution of fibers. Even a dual-processor configuration, in which one processor is dedicated to fiber support, would not be as effective. Most general-purpose processors would have to communicate through memory, while a special-purpose device could use a memory-mapped I/O, which would allow for optimizations such as using different addresses for different operations. This would speed up the dispatching of event requests from the EU 12.

Second, operations performed in hardware would be much faster in many cases. Many of the operations for fiber support would involve simple subtasks such as checking counters and following pointers. These could be combined and performed in parallel in perhaps only a few clock cycles, whereas emulating them in software might require 10 or 20 instructions with some conditional branches. Some operations might require tasks such as associative searches of queues or explicit cache control, which can be performed quickly by custom hardware but are generally not possible in general-purpose processors except as long loops.

Finally, as previously mentioned, many of the SU's 14 tasks can be done in parallel. A conventional processor would have to switch between these tasks.

In general, these three differences would contribute to fiber efficiency in a system with a hardware SU. Offloading fiber operations to the SU 14 and speeding up those operations would reduce the overheads associated with each fiber, making each fiber cheaper. A faster load-balancer, running in parallel with other components, would be able to spread fibers around more quickly, or alternately, to implement a more advanced load-balancing scheme to produce more optimal results. In either case, work would be distributed more evenly. Finally, special-purpose hardware would be able to process communication and synchronization between fibers more rapidly, allowing programmers and compilers to use threads which are more asynchronous.

C. Description Of The EVISA Real-time Multithreading Features

The EVISA architecture has mechanisms to support real-time applications. A primary mechanism is the support of prioritized fiber scheduling and interrupts by the SU 14. First, threads (fibers) are ranked by priorities according to their real-time constraints. In the internal ready queue 30, the fibers are ordered by their priority assignments and the SU 14 scheduling mechanism will give preference of execution for high priority fibers. Events and network messages may also be prioritized, so that high-priority events and messages are serviced before others.

For instance, each fiber code could have an associated priority, one of a small number of priority levels, or the priority level could be specified as a separate field in a sync slot. In either case, when a fiber is enabled and placed in the RQ 16, some bits of the properties field would be set to the specified priority level. When the EU 12 fetches a new fiber from the RQ 16, any fiber with a certain priority level would have priority over any fiber with a lower level.

Second, a fiber already in execution may be interrupted should a fiber with sufficient priority arrive. This requires an extension of the fiber execution model by permitting interrupts to occur should such an event occur. The SU 14 may use existing mechanisms provided by the EU 12 for interrupting and switching to another task, though these are usually costly in terms of CPU cycles due to the overhead of saving the process state when an interrupt occurs at an arbitrary time. Two specific priority levels would be included in the set of priority levels. The first, called Procedure-level Interrupt, would permit a fiber to interrupt any other fiber belonging to the same threaded procedure. The second, called System-level Interrupt, would permit a fiber to interrupt any other fiber, even if it belonged to a different threaded procedure. When the SU 14 enables a fiber with either of these priority levels, the SU 14 will check the FID/IP unit 32 for an appropriate fiber (typically the one with lowest priority), determine from the FID/IP unit 32 which FU is running the chosen fiber, and generate the interrupt for that FU.

A separate mechanism may be used for “hard” real-time constraints, in which a fiber must be executed within a specified time. Such fibers would have a timestamp field included in the RQ 16. This timestamp would indicate the time by which the fiber must begin execution to ensure correct behavior in a system with real-time constraints. Timestamps in the RQ 16 would be continuously compared to a real-time clock by the RT manager 44. As with the priority bits in the properties field, timestamps would be used to select fibers with higher priority, in this case the fibers with earlier timestamps. If the RT manager's 44 clock were about to reach the value in the timestamp of a fiber in the RQ 16, the RT manager 44 could generate an interrupt of one of the fibers then in the EU 12, in the same manner in which fibers are interrupted by fibers with Procedure-level or System-level priority.

To reduce the incidence of interrupts, with their high overheads, the executing fiber could have pre-programmed polling points in its code, and could check the RQ 16 when such a point is reached. If any high-priority fibers are waiting in the RQ 16 at this time, the executing fiber could save its own state and turn over control to the high-priority fiber. Compiler technology could be responsible for inserting the polling points as well as for determining the resolution (temporal interval) between polling points, in order to meet the requirement of real-time response and minimize the overhead of state saving and restoring during such an interrupt. However, if a polling event does not occur sufficiently quickly to satisfy a real-time constraint, the previously-described mechanism would be invoked and the RT manager 44 would generate an interrupt.

A final mechanism uses other bits in the properties field of the RQ 16 to enforce scheduling constraints when an EU 12 can execute two or more fibers simultaneously. Some fibers may be used for accessing shared resources (such as variables), and need to be within “critical regions” of code, whereby only one fiber accessing the resource can be executing at a given time. Critical regions can be enforced in an SU 14 which knows the identities of all fibers currently running (from the FID/IP unit 32), by setting additional bits in the properties field of the RQ 16 entry to label a fiber either “fiber-atomic” or “procedure-atomic.” A fiber-atomic fiber cannot run while an identical fiber (one with the same FID and IP) is running. A procedure-atomic fiber cannot run while any fiber belonging to the same threaded procedure (i.e., any fiber with the same FID) is currently running.

D. Description Of The EVISA Real-time Multithreading Programming Model

Any combination of the EVISA components described herein with any custom- or COTS-based EU is hereinafter referred to as an EVISA Virtual Machine (EVM). One requirement of any EVM is that the instruction set contains at least the basic EVISA operations, implemented consistent with the memory model and data type set for the EU 12. Refinements and extensions are permissible once the basic requirement is met. EVISA relies on various operations for sequencing and manipulating threads and fibers. These operations perform the following functions: (1) invocation and termination of procedures and fibers; (2) creation and manipulation of sync slots; and (3) sending of sync signals to sync slots, either alone or atomically bound with data.

Some of these functions are performed atomically, generally as a result of other EVISA operations. For instance, the sending of a sync signal to a sync slot with a current sync count of one causes the slot count to be reset and a fiber to become enabled. Eventually, that fiber becomes active and begins execution. But some operations, such as procedure invocation, are explicitly triggered by the application code. This section lists and defines eight explicit (program-level) operations which are preferably used with a machine implementing the EVISA thread model.

These sections define the basic functionality present in any machine that supports EVISA by providing a preferred embodiment of this functionality in the preferred set of data types and operations. Other sets of data types and operations to accomplish the same functionality may be readily constructed by those of ordinary skill in the art.

1. Basic EVISA Data Types

The following data types and functions are used by the operators.

A frame identifier (FID) is a unique reference to the frame containing the local context of one procedure instance. It is possible to access the local variables, input parameters, and sync slots of this procedure, as well as the procedure code itself, using the FID, in a manner specified by the EVM. The FID is globally unique across all nodes. No two frames, even if on different nodes, have the same FID simultaneously. An FID may incorporate the local memory address of the frame. If not, then if a frame is local to a particular node, mechanisms are provided on that node to convert the FID to the local memory address.

An instruction pointer (IP) is a unique reference to the designated first instruction of a particular fiber code within a particular threaded procedure. A combination of an FID and IP specify a particular instance of a fiber.

A procedure pointer (PP) is a unique reference to the start of the code of a threaded procedure, but not a specific instance. Through this reference, the EVM is able to access all information necessary to start a new instance of a procedure.

A unique synchronization slot (SS) consists of a Sync Count (SC), Reset Count (RC), Instruction Pointer (IP) and Frame Identifier (FID). The first two fields are non-negative integers. The expression SS.SC refers to the sync count of SS, etc. However, this is for descriptive purposes only. These fields should not be manipulated by the application program except through the special EVISA operators listed below. The SS type includes enough information to identify a single sync slot which is unique across all nodes. How much information is required depends on the operator and the EVM. In some cases, the sync slot may be restricted to a particular frame, which means that only a number, identifying the slot within that frame, is needed. In other cases, a complete global address is required (such as a pair consisting of an FID and a sync slot number).

In the list of EVISA operators, type T means an arbitrary object, either scalar or compound (array or record). This class of objects can include any of the reference data types listed above (FID, IP, PP, SS), so that these objects can also be used in EVISA operations (e.g., they can be transferred to another procedure instance). Type T can also include any instance of the reference data type that follows.

For each object of type T, there is a reference to that object, of type reference-to-T, through which that object can be accessed or updated. In accordance with the memory requirements, this must be globally unique and all processing elements must be able to access the object of type T using the reference. The term “reference” is used, instead of “pointer” or “address”, to prevent any unwarranted assumptions about the kinds of operations that can be performed with these references.

The following lists the eight operations, describing the role of each operation, and the behavior that must be supported by the EVM. The list also suggests options that might be added in the EVM. In the list, the “current fiber” is the fiber executing the operation, and the “current frame” is the FID corresponding to the current fiber.

2. Basic EVISA Thread Control Operations

Thread control operations control the creation and termination of threads (fibers and procedures) based on the EVISA thread model. The primary operation is procedure invocation. There must also be operators to mark the end of a fiber and to terminate a procedure. No explicit operators to create fibers are needed, as fibers are enabled implicitly. One fiber is enabled automatically when a procedure is invoked, and others are enabled as a result of sync signals.

A program compiled for EVISA designates one procedure that is automatically invoked when the program is started. Only one instance of this procedure is invoked, even if there are multiple processors. Other processors remain idle until procedures are invoked on them. This distinguishes EVISA from parallel models such as SPMD (single processor/multiple data), where identical copies of a program are started simultaneously on all nodes.

The INVOKE(PP proc, T arg1, T arg2, . . . ) operator invokes procedure (proc). It allocates a flame appropriate for proc, initializes its input parameters to arg1, arg2, etc., and enables the IP for the initial fiber of proc. The EVM may set restrictions on what types of arguments can be passed, such as scalar values only. The system guarantees that the frame contents, as seen by the processing element that executes proc, are initialized before the execution of proc begins. In multiprocessor systems, the INVOKE operator may include an additional argument to specify a processor on which to run the procedure, or to indicate that the SU 14 should determine where to run the procedure using a load-balancing mechanism.

The TERMINATE_FIBER operator terminates the current fiber. The processing element that ran this fiber is free to reassign the processing resources used for this fiber, and to begin execution of another enabled fiber, if one exists. If there are none, the processing element waits until one becomes available, and begins execution.

The TERMINATE_PROCEDURE operator is similar to TERMINATE_FIBER, but it also terminates the procedure instance corresponding to the current fiber. The current frame is deallocated. This description does not specify what happens to any other fibers belonging to this instance if they are active or enabled, or what happens if the contents of the current frame are accessed after deallocation. The EVM may define behavior which occurs in these cases, or define such an occurrence as an error which is the compiler's (or programmer's) responsibility to avoid.

3. Basic EVISA Sync Slot Control Operations

Sync slots are used to control the enabling of fibers and to count how many dependencies have been satisfied. They must be initialized with values before they can receive sync signals. It would be possible to make sync slot initialization an automatic part of procedure invocation. Prior experience with programming multithreaded machines have shown that the number of dependencies may vary from one instance of a procedure to the next, and may depend on conditions not known at compile time (or even at the time the procedure is invoked). Therefore, it is preferable to have an explicit operation for initializing sync slots. Of course, a particular implementation of EVISA may optimize by moving slot initialization into the frame initialization stage if the initialization can be fixed at compile time.

The operator INITIALIZE_SLOT(SS slot, int SC, int RC, IP fib) initializes the sync slot specified in the first argument, giving it a sync count of SC, a reset count of RC, and an IP fib. Only sync slots in the current frame can be initialized (hence, no FID is required). Normally, sync slots are initialized in the initial fiber of a procedure. However, an already-initialized slot may be re-initialized, which allows slots to be reused much like registers.

There is the potential for race conditions between the initialization or re-initialization of a thread and the sending of sync signals to that thread. The EVM and implementation should guarantee sequential ordering between slot initialization and slot use within the same fiber. For instance, if an INITIALIZE_SLOT operator that initializes slot is followed in the same fiber by an explicit sending of a sync signal to slot, the system should guarantee that the new values in slot (placed there by the initialization) are in place before the sync signal has any effect on the slot. On the other hand, it is the programmer's responsibility to avoid race conditions between fibers. The programmer should also avoid re-initializing a sync slot if there is the possibility that other fibers in the system may be sending sync signals to that slot.

The INCREMENT_SLOT(SS slot, int inc) operator increments slot.SC by inc. Only slots in the local frame can be affected. The ordering constraints for the INITIALIZE_SLOT operator apply to this operator as well.

This is a very useful operation for procedures where the number of dependences is not only dynamic, but cannot be determined at the time a sync slot would normally be initialized. An example is traversing a tree where the branching factor varies dynamically, such as searching the future moves in a chess game, where the number of moves to search at each level is determined at runtime.

In an example of a tree traversal algorithm in a chess program, an array is allocated for holding result data, and each child is given a reference to a different location to which the results of one move are sent. Each child is started by a first parent fiber and sends a sync signal to sync slot s upon completion. A second parent fiber which chooses a move from among all the sub-searches should be enabled when all children are done. Since the number of legal moves varies from one instance to the next, the total number of procedures invoked is not known when the slot is initialized in the initial thread. The INCREMENT_SLOT operator is used to add one to the sync count in slot.SC before invoking a child. If, after the first child is invoked, the child sends a sync signal back before the loop in the first parent fiber performs another INCREMENT_SLOT, the count slot.SC could decrement to zero, prematurely enabling the second parent fiber 2. To avoid this possibility, the count should start at 1, ensuring that the count is always at least one provided the slot is incremented before the INVOKE occurs. When all increments have been performed, it is safe to remove this offset, after which the last child to send a sync signal back will trigger fiber 2. An INCREMENT_SLOT with a negative count (i.e., −1) does this. Alternately, a SYNC operation, covered next, would have the same effect.

The synchronization slot mechanisms can be invoked implicitly through linguistic extensions to a programming language supporting threaded procedures and fibers. One such extension is through the use of sensitivity lists. A fiber may be labeled with a sensitivity list which identifies all the input data it needs to begin processing. By analyzing such a list and the flow of data through the threaded procedure, a corresponding set of synchronization slots and synchronization operations can be derived automatically for proper synchronization of parallel fiber execution.

4. Basic EVISA Synchronizing Operations

The synchronizing operators give EVISA the ability to enforce data and control dependencies between procedures, even those not directly related, enabling the programmer to create many parallel control structures besides simple recursion. Thus, the programmer can tailor the control structures to the needs of the application. This section describes the fundamental requirements for EVISA synchronization with three (3) operations, but alternative operations sets may be devised to meet the same requirements. This section also illustrates useful extensions to these fundamental capabilities which build on the foundations of the present invention.

Three basic synchronizing operations are offered by EVISA: (1) synchronization alone; (2) producer-oriented versions of synchronization bound with data transfers; and (3) consumer-oriented versions of synchronization bound with data transfers.

SYNC(SS slot) is the basic synchronization operator. The count of the specified sync slot (slot.SC) is decremented. If the resulting value is zero, the fiber (FID_of(slot), slot.F) is enabled, and the sync count is updated with the reset count slot.RC. Otherwise, the sync count is updated with the decremented value. The implementation guarantees that the test-and-update access to the SC field is atomic, relative to other operators that can affect the same slot (including the slot control operators).

It is important to bind data transfers with sync signals, to avoid a race condition in which a sync signal indicates the satisfying of a data dependence and enabled a fiber before the data in question has actually been transferred. This binding is done in EVISA by augmenting a normal SYNC operator with a datum and a reference to produce a SYNC_WITH_DATA(T val, reference-to-T dest, SS slot) operator. The system copies the datum value to the location referenced by dest, then sends the sync signal to slot.

The system guarantees that the data transfer is complete before the sync signal is sent to the slot. More precisely, the system guarantees that, at the time a processing element starts executing a fiber enabled as a direct or indirect result of the sync signal sent to a slot, that processor sees val at the location dest. A direct result means that the sync signal decrements the sync count to zero, while an indirect result means that a subsequent signal to the same slot decrements the count to zero. The system also guarantees that, after the sync slot is updated, it is safe to change val. This is mostly relevant if val is passed “by reference,” e.g., as is usually done with arrays.

SYNC_WITH_FETCH(reference-to-T source, reference-to-T dest, SS slot) is the final operator of the EVISA set, and also binds a sync signal with a data transfer, but the direction of the transfer is reversed. While the previous operator takes a value as its first argument, which must be locally available, the SYNC_WITH_FETCH specifies a location that can be anywhere, even on a remote node. A datum of type T is copied from the source to the destination. The ordering constraints are the same as for SYNC_WITH_DATA, except that val (in the previous paragraph) now refers to the datum referenced by source.

This operator is primarily used for fetching remote data through the use of split-phase transactions. Data is remote if its access incurs relatively long latency. Remote data exists in computer systems with a distributed memory architecture, in which processor nodes with local memory are connected via an interconnection network. Remote data also exists in some implementations of shared memory systems with multiple processors, referred to in the literature as NUMA (Non-uniform memory access) architectures. If a procedure needs to fetch data which is likely to be remote, the fiber initiating the fetch should not wait for the data, which may take a relatively long time. Instead, the consumer of the data should be in another fiber, with a SYNC_WITH_FETCH used to synchronize a slot and enable the consumer when the data is received.

This operation is considered “atomic” only from the point of view of the fiber initiating the operation. In fact, the operation typically occurs in two phases: the request is forwarded to the location of the source data (on a distributed-memory machine), and then, after the data has been fetched, it is transferred back to the original fiber. The SS reference is bound to both transfers, so that the system guarantees the data is copied to dest before any fibers begin execution as a direct or indirect result of the sync signal sent to slot.

These three operators would likely be fundamental to any EVISA EVM, but variations and extended operators are possible. For example, there may be fibers that only need to wait for one datum or control event, which would imply a sync slot with a reset count of one. For such cases, the EVM may define special versions of the operators that enable the fiber directly rather than going through a sync slot, saving time and sync slot space. These are optional, however, as the same effect can be achieved with regular sync slots.

Another variation is dividing the arguments to these operators between the EU 12 and the SU 14. The operators SYNC_WITH_DATA and SYNC_WITH_FETCH combine sync slots with locations to store data. Rather than specifying both arguments from a fiber executing on the EU 12, the EVM could provide a means for the program to couple the sync slot and data location in the SU 14, and thereafter the fiber would only need to specify the data location; the SU 14 would add the missing sync slot to the operator.

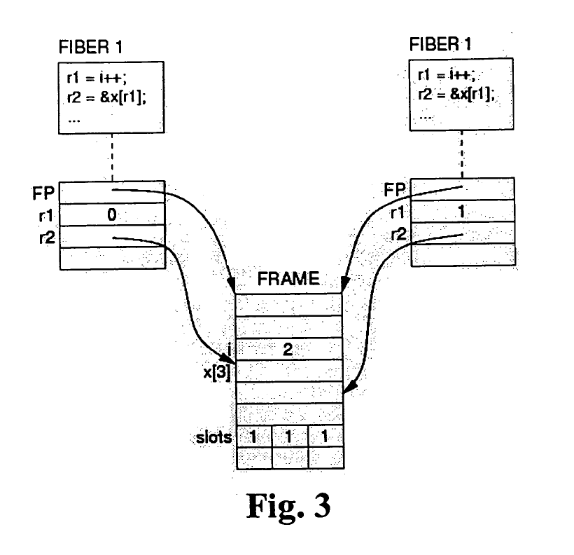

There can be potential race conditions in EVISA. One example is enabling a fiber while another instance of the same fiber in the same procedure instance is active or enabled. This is not necessarily an error under EVISA, but can work properly under special conditions. FIG. 3 illustrates the situation arising from having two instances of the same fiber in the same procedure instance simultaneously active. Technically, each fiber has its own context, so it would be possible for the two to run concurrently without interfering with each other. However, they still share the same frame, and any input data they require must come from this frame, either directly (the data is in the frame itself) or indirectly (a reference to the data is in the frame), since all local fiber context, except the FID itself, come from the frame. If both fibers copy the same data and references, they will operate redundantly. If each loads its initial register values from values in the frame and then updates the frame values, it is possible for the fibers to work concurrently on independent data. FIG. 3 shows each fiber working with a different element of an array x, and shows the state after each fiber has copied the reference to register r2. But correct operation of this code under all circumstances requires additional hardware mechanisms and adopting specific programming styles.

First, if the hardware allows the two fibers to run concurrently, it must support automatic access to the frame variable i, e.g., a fetch-and-add primitive. This can be an extension to the instruction set supported by the EU 12. Alternately, a value can be stored in an extra field contained within the RQ 16, and the EU 12 can load one register from this field of the RQ 16 rather than from the frame. This field could hold, for instance, the index of the array element. Second, if the fibers were triggered by separate sync signals bound with automatic data transfers (note the first slot in the frame has a count of 1 and triggers fiber 1), the two producers of the data (assume in this case that it is sent to x[ ]) must be programmed to send the two values to separate locations in x[ ].

This example illustrates how the EVISA architecture can be extended by adding synchronization capabilities to be managed either in the SU 14 or the EU 12 to support a richer set of control structures while retaining the fundamental advantages of this invention.

It will be apparent to those skilled in the art that various modifications and variations can be made in the method and apparatus for real-time multithreading of the present invention and in construction of the method and apparatus without departing from the scope or spirit of the invention. Examples of which have been previously provided above.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A real-time multithreading apparatus, comprising:
one or more multithreading nodes connected by an interconnection network, each multithreading node comprising:
an execution unit for executing active fibers;
a synchronization unit for scheduling and synchronizing fibers and procedures, and handling remote accesses, the synchronization unit interconnecting with the interconnection network; and
a ready queue and an event queue through which the execution unit and the synchronization unit communicate.

2. A real-time multithreading apparatus as recited in claim 1, wherein the execution unit has at least one computer processor interconnected with a memory bus.

3. A real-time multithreading apparatus as recited in claim 2, wherein the ready queue provides information received from the synchronization unit to the at least one computer processor of the execution unit.

4. A real-time multithreading apparatus as recited in claim 2, wherein the event queue provides information received from the at least one computer processor of the execution unit to the synchronization unit.

5. A real-time multithreading apparatus as recited in claim 1, further comprising a memory interconnected with and shared by the execution unit and the synchronization unit.

6. A real-time multithreading apparatus as recited in claim 1, wherein if a fiber running on the execution unit needs to perform an operation relating to other fibers, the execution unit sends a request to the event queue for processing by the synchronization unit.

7. A real-time multithreading apparatus as recited in claim 1, wherein the synchronization unit manages fibers and places any fiber ready for execution in the ready queue.

8. A real-time multithreading apparatus as recited in claim 1, wherein the synchronization unit comprises:
a system bus interface through which the execution unit accesses the event queue and the ready queue, and through which the synchronization unit accesses a memory; and
a network interface through which the synchronization unit interconnects with the interconnection network.

9. A real-time multithreading apparatus as recited in claim 8, wherein the synchronization unit further comprises:
an internal event queue containing uncompleted events waiting to be finished or forwarded to another node;
an internal ready queue containing a list of fibers ready to be executed; and
a frame identifier/instruction pointer section storing information relevant to each fiber currently being executed by the execution unit.

10. A real-time multithreading apparatus as recited in claim 9, wherein the synchronization unit further comprises:
an outgoing message queue buffering messages waiting to go out over the interconnection network;
a token queue holding all pending threaded procedure invocations that have not been assigned to a node; and
an internal cache holding recently-accessed sync slots and data read by the synchronization unit.

11. A real-time multithreading apparatus as recited in claim 10, wherein the synchronization unit further comprises:
an execution unit message assembly area collecting sequences of stores from the system bus interface and injecting completed events in the event queue;
a network message assembly area receiving incoming messages and injecting completed messages into the event queue; and
a distributed real-time manager ensuring that events, messages, and fibers with high priority or real-time constraints are placed ahead of objects with lesser priority.

12. A real-time multithreading method, comprising:
providing one or more multithreading nodes connected by an interconnection network, each multithreading node performing a method comprising:
executing active fibers with an execution unit;
scheduling and synchronizing fibers and procedures, and handling remote accesses with a synchronization unit interconnected with the interconnection network; and
providing communication between the execution unit and the synchronization unit with a ready queue and an event queue.

13. A real-time multithreading method as recited in claim 12, wherein the execution unit has at least one computer processor interconnected with a memory bus.

14. A real-time multithreading method as recited in claim 13, wherein the providing communication substep includes providing information received from the synchronization unit to the at least one computer processor of the execution unit with the ready queue.

15. A real-time multithreading method as recited in claim 13, wherein the providing communication substep includes providing information received from the at least one computer processor of the execution unit to the synchronization unit with the event queue.

16. A real-time multithreading method as recited in claim 12, wherein each multithreading node performs a method further comprising interconnecting a memory with the execution unit and the synchronization unit.

17. A real-time multithreading method as recited in claim 12, wherein the scheduling and synchronizing fibers and procedures substep includes sending a request to the event queue for processing by the synchronization unit by the execution unit if a fiber running on the execution unit needs to perform an operation relating to other fibers.

18. A real-time multithreading method as recited in claim 12, wherein the scheduling and synchronizing fibers and procedures substep includes managing fibers and placing any fiber ready for execution in the ready queue with the synchronization unit.

19. A real-time multithreading method as recited in claim 1, wherein the scheduling and synchronizing fibers and procedures substep comprises:
providing a system bus interface through which the execution unit accesses the event queue and the ready queue, and through which the synchronization unit accesses a memory; and
providing a network interface through which the synchronization unit interconnects with the interconnection network.

20. A real-time multithreading method as recited in claim 19, wherein the scheduling and synchronizing fibers and procedures substep further comprises:
providing an internal event queue that contains uncompleted events waiting to be finished or forwarded to another node;
providing an internal ready queue that contains a list of fibers ready to be executed; and
providing a frame identifier/instruction pointer section that stores information relevant to each fiber currently being executed by the execution unit.

21. A real-time multithreading method as recited in claim 20, wherein the scheduling and synchronizing fibers and procedures substep further comprises:
providing an outgoing message queue that buffers messages waiting to go out over the interconnection network;
providing a token queue that holds all pending threaded procedure invocations that have not been assigned to a node; and
providing an internal cache that holds recently-accessed sync slots and data read by the synchronization unit.

22. A real-time multithreading method as recited in claim 21, wherein the scheduling and synchronizing fibers and procedures substep further comprises:
providing an execution unit message assembly area that collects sequences of stores from the system bus interface and injects completed events in the event queue;
providing a network message assembly area that receives incoming messages and injects completed messages into the event queue; and
providing a distributed real-time manager that ensures events, messages, and fibers with high priority or real-time constraints are placed ahead of objects with lesser priority.
